(19) United States
(12) Patent Application Publication
(10) Pub. No.: US 2008/0230240 A1
(43) Pub. Date: Sep. 25, 2008

(54) Front suspension for a yard tool

(76) Inventor: Edward Patrick Hurley, Sarasota, FL (US)

Correspondence Address: Edward P. Hurley, 1214 Western Pine Cir., Sarasota, FL, 34240, US

(21) Appl. No.: 12/156,397

(22) Filed: May 30, 2008

Related U.S. Application Data
(63) Continuation-in-part of application No. 11/585,707, filed on Oct. 24, 2006.

(51) Int. Cl. A01D 34/84; B26B 25/00; B26B 29/06; A01D 34/416; A01D 34/67; A01G 3/06; A01D 34/90

(52) U.S. Cl. 172/14; 30/123; 172/17; 30/275.4; 30/276; 56/12.7

(57) ABSTRACT

A front suspension for a yard tool mounted on a bracket to a boom, the bracket having to support a drive shaft, a cutting disk, a shield and one or more front suspensions to dampen power transfer, the front suspension having a frame preferably connected to a wheel at a distal end and coupled to the bracket at a proximal end, the front suspension operated in parallel single orthogonal fold frameworks with height and width adjustments substantially below the yard tool center of mass, the front suspension having to support the yard tool in equilibrium in all operative and inoperative positions to save power, to guide the cutting disk with a longer and straighter cut, to dampen the cutting disk resistance adjacent to hard surfaces, and to fold away for the shield and cutting disk to perform soft yard grounds work.

### CROSS REFERENCE TO RELATED APPLICATIONS

This is an abandonment of Ser. No. 12/148,910, filed on Apr. 23, 2008 due to an error in judgment involving center of mass properties and is a continuation in part of Ser. No. 11/585,707, filed on Oct. 24, 2006.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of grounds maintenance and more specifically to a front suspension for a yard tool. There can be as much as three-million five-hundred thousand retail hand held lawn string trimmers and two-million commercial trimming units sold in America each year. A basic survey of the US home and garden retail market conceivably shows that about thirty-two string trimmers, eighteen blowers and four steel edgers are regularly put on display for lawn care use. Accordingly, the display ratio clearly shows that a majority of US string trimmers could be facilitated as lawn edgers when retail metallic lawn edgers are given less focus. Manufacturers have tried to level the playing field of their product line ratio by adding shaft mid-section quick links to string trimmers which permits the use of a steel lawn edger or blower attachment. However, splitting a drive shaft will likely generate a significant amount of machine vibration and the interchanging process may become difficult to manage. As a result, many lawn care providers are encouraged to integrate horizontal grounds trimming with vertical lawn edging.

Home string trimming work is assumed to be about forty hours each year whereas more scrutinized commercial hand held power tools can be operated five times longer. Commercial lawn power tools are by and large reviewed more carefully by safety regulators because of the time they are operated by professional landscapers. As a result, retail string trimmer outlets will try to market more tool features knowing that their dominant lawn tool sector is less likely to be the focus of machine operation. It is important not to confuse machine operation with tool resistance because the two separate variables can add up to an important health risk. For example, let's say a string trimmer produces 1 Nm/s2 of machine force when operating in thin air and 8 Nm/s2 when cutting vertically down on hard pavement or horizontally on grave stones or fences at the same speed level. In this case, both the machine and tool resistance vibration are factored into what could be absorbed into an operator which is a waste of energy. Tilting a lawn tool into an oblique position for lighter lawn care use can add to safety and energy conservation problems because the method tends to remove and scatter an enormous amount of grounds projectiles from landscape beds and lowers wounds to property and plants closer to soil where pests will thrive. Furthermore, many lawns are trimmed inconsistently without much support. Therefore, the standards for lawn care should raise a few questions about safer ways to conserve energy.

There are some on-going tool resistance concerns when string trimmers are implemented as lawn edgers. First, local governments are now encouraging more home grown garden beds which is acceptable for soft surfaces, but the process could put excess strain on an operator and even cause steel edgers to fail because of low moisture count in hard soil. Secondly, professional landscape companies make more profits when converting properties into colorful grounds beds which may further increase lawn care resistance. Third, an economic downturn may discourage the use of steel lawn edgers even though they should be alternated with string trimmer grooming exercises. Forth, many string trimmers face about a five inch string line filament overlap problem associated with D handle grips. Fifth, some new string line products are adding metallic resins to their product lines that can increase tool life, but will also add proportionally to the overall tool resistance when not deflected properly. Sixth, several retail string trimmers are sold with fixed string line filament which can wear down to multiple levels to create arm and back strain. Finally, power tool speeds up to 10,000 rpm can generate significant high frequency vibration when there is little or no support to prevent a flexible cord or steel blade from overlapping a hard pavement. Most of these drawbacks can be reasonably dealt with by utilizing a front suspension on hand held string trimmers.

There are several inventions related to a front suspension for a hand held string trimmer. For instance, U.S. Pat. No. 5,477,665 ('77665) describes a strut that supports a string trimmer. U.S. Pat. No. 5,107,665 shows a spatial guide to maneuver a string trimmer over a hard pavement. U.S. Pat. No. 5,351,762 presents a clever adapter that will count the distance of high resistance strain. U.S. Pat. No. 5,829,236 relates to a carrying device with wheels used to support a string trimmer. U.S. Pat. No. 6,116,349 discloses a double fold edging guide. U.S. Pat. No. 7,168,726 claims to have a suspension with an optimal wheel and fork construction. What can one say, the inventor of U.S. Pat. No. 2,832,184 knew his stuff. Finally, U.S. Pat. No. 5,115,870 focuses on eliminating the use of a steel edger with a flail trimmer and combined edging guide.

The strut support of '77665 presents a problem because it is already difficult to encourage the use of a shield let alone an elongated strut. Sometimes a strut is troublesome to flow through thick debris and grass. It is hard to prevent the tip of the string trimmer from overlapping a hard grounds surface when U.S. Pat. No. '77665 is used for lawn edging which could translate a lot of strain to an operator. The spatial guide of '07665 appears to time consuming to adjust. Furthermore, '07665 mounts substantially near the cutting guard proximal end which can obstruct a safe view of the cutting plane and exposes the immediate cutting portion to an operator. The edging roller and trimming guard of '07665 clearly shows a double orthogonal fold method for lawn care which doubles the effort and adds excess strain to an operator when compared to a frontal single orthogonal fold method. The smart adapter of '51762 doesn't appear to adjust to grounds contours or various string line heights to minimize resistance vibration. However, '51762 is also a double orthogonal fold method that forces an operator to edge lawns while walking sideways or having to turn their neck in an awkward way which also limits the view of oncoming objects. An interesting finding about '51762 and other similar art is that the handle tends to be flipped into similar holding patterns which will make the cutting plane unstable. U.S. Pat. No. '29236 looks like a grocery cart that may get stuck in ruts. Grocery carts are difficult to lift up when they get hung up in grass. The weight of '29236 may cause mud to track into a storage room. Furthermore, '29236 could discourage lawn care because of its material size and weight even though the invention attempts to put a bigger footprint on lawn care safety.

The suspension of invention '68726 is a superb example of frame construction and material design. However, '68726 carries about twenty times more weight than a yard tool suspension which could be difficult to hold over soft vegetation. It is important to note that large diameter fast rotating wheels will sometimes lodge in grooves which could easily flip a hard working trailblazer over the '68726 invention. Consequently, a cutting tool attached at the '68726 front end would have the potential of running over a thrown operator since many handheld yard trimmers are semi-exposed in the front. The wheel of invention '68726 pivots on a vertical axis which would likely cause a wave appearance during vertical lawn edging. The wishbone suspension of '68726 appears to be free of a rearward shield or fender to prevent a foot from slipping off a pedal and into an attached cutter. The rigid spring of '68726 may even assist with an operator overturning when the front suspension gets jammed.

U.S. Pat. No. '16,349 permits a larger amount of projectiles to disperse towards an operator when the shield is furthest from ground level while the cutter is exposed to an operator during lawn edging. U.S. Pat. No. '16349 appears to be an open frame for large debris to pass through to an operator whereas wheels will block more debris. Conversely, the '16349 flail trimmer invention allows more projectiles to disperse or deflect towards an operator because the cutter is not tucked away during grounds trimming. Both '16349 and '15870 guides will ride on soil which could create significant resistance vibration. The '15870 invention has a shield cover that seems to blind the lawn care activity potentially causing turf grass to be scalped for an unattractive lawn appearance. The tornado shaped guiding device of '15870 may pose a suction problem that could eventually lead to string line oscillation or may even draw tall grass around the cutting spindle. The '15870 and '16349 guides appear to be difficult to release and control. The '16349 invention may get hung up on vegetation which could discourage its use. Significant heat may be stored by '16349 as resistance vibration is translated from the ground to the motor casing. Heat buildup could eventually become a fire hazard; especially if the '16349 wiring system comes loose from vibration. Electric tools like '16349 can become a serious fire hazard by giving off sparks near common gas fumes emitted by power tools, mowers, automobiles, gas pipe lines, fuel storage tanks and the like. In addition, '16349 is balanced near the frontal handle which allows the guide and cutter to swing into an operator by accident. The '32184 trimming tool provides a noteworthy bracket for its day. However, the '32184 bracket becomes time consuming when switching an unpopular roller for soft grounds trimming to a wheel for more common hard pavement lawn edging. The smoke pipe is exposed to the cutter of Invention '32184 which could drop into the reciprocal blades when the roller gets stuck to dull the exercise.

A new front suspension that is oriented diagonal to an operator in an orthogonal isometry framework, that improves both hard and soft lawn grooming practices should prevent grass fires caused by '32184 smoke pipes.

### BRIEF SUMMARY OF THE INVENTION

The primary object of the invention is to provide a yard tool center of mass that is substantially above a front suspension.

Another object of the invention is to provide the yard tool with less shock during transport and operation.

Another object of the invention is to provide the yard tool with better symmetrical balance for horizontal yard trimming.

A further object of the invention is to provide the yard tool with better symmetrical balance for vertical lawn edging.

Yet another object of the invention is to provide the yard tool with a more accurate cutting and safety guide.

Still yet another object of the invention is to provide the yard tool with consistent pressure during operator walk motions.

Another object of the invention is to provide the yard tool with less worker fatigue.

Another object of the invention is to provide the yard tool front suspension with right and left handed ergonomic options for better view of oncoming objects.

A further object of the invention is to provide the front suspension with a pair of mirrored diagonal transport paths for an operator to stay out of the operating and debris paths.

Yet another object of the invention is to provide the front suspension with a pair of mirrored orthogonal isometry operating frameworks congruent with the grounds tool operation.

Still yet another object of the invention is to provide the front suspension with a quick adjustment option free of having to bend over to grab onto the grounds tool.

Another object of the invention is to provide the front suspension with a handy lock down alternative.

Another object of the invention is to provide the front suspension with a parallel cutting guide that is capable of minimizing forward or rearward dispersion of debris.

A further object of the invention is to provide the operator with less risk of being soiled from mud, mold and the like which will further prevent falls.

Yet another object of the invention is to provide the yard tool with greater swing back protection when a supervisor accidentally taps on an operator's shoulder.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a front suspension for a yard tool comprising: a yard tool, the yard tool having a power source, the yard tool having means for a cutting disk free of using a tool, the yard tool having means for a shield, the yard tool having a drive shaft, the drive shaft substantially contained within a boom, the boom suspended and controlled by a handlebar, the cutting disk, handlebar and power source mounted on the boom center line of rotational symmetry, the cutting disk substantially operated within mirrored single orthogonal fold frameworks, a bracket mounted to the boom, the bracket having means to support the drive shaft, the cutting disk, the shield and one or more front suspensions, the front suspension having means to dampen the power transfer, the front suspension having a frame, the frame connected to a wheel or the like at a distal end and coupled to the bracket at a proximal end, the front suspension operated parallel to the single orthogonal fold frameworks, the front suspension having means for height adjustments of the yard tool, the front suspension operated substantially below the yard tool center of mass, the front suspension having means to support the yard tool in equilibrium in all operative positions, the front suspension having means to support the yard tool in equilibrium in all inoperative positions, the front suspension having means to save power, the front suspension having means to guide the cutting disk with a longer and straighter cut, the front suspension having means to dampen the cutting disk resistance adjacent to hard surfaces, and the handlebar having means to fold the front suspension away for the shield and cutting disk to perform soft yard grounds work.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the front suspension.

FIG. 2a is a cross-section of FIG. 1 illustrating the front suspension with a spring fastener.

FIG. 2b is a perspective view of FIG. 1 illustrating the front suspension with a knob fastener.

FIG. 2c is a perspective view of FIG. 1 illustrating a straight frame.

FIG. 3 is a perspective view of FIG. 1 illustrating a looped frame.

FIG. 4a is a side view of FIG. 1 illustrating the front suspension in use rolling on hard grounds pavement.

FIG. 4b is a side view of FIG. 1 illustrating the front suspension folded away from grounds contact.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

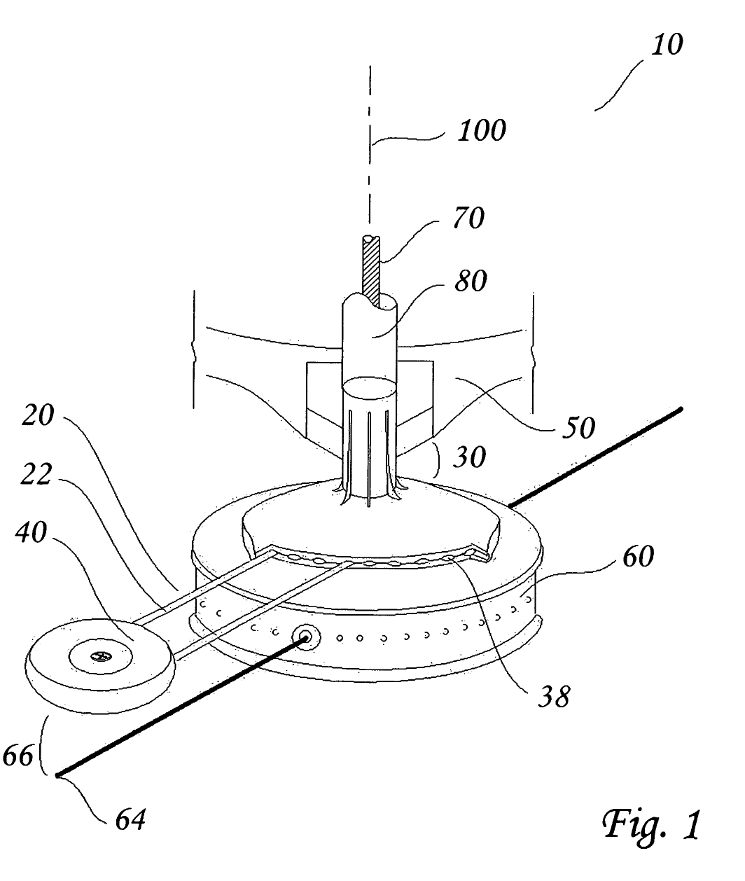

Referring to FIG. 1, a yard tool 10 comprising a drive shaft 70 substantially contained within a boom 80, the boom suspended and controlled by a handlebar (not shown) that is handheld to substantially bear the load of a power source (not shown), and a cutting disk 60 or the like that are mounted on the boom 80 front end on a center line of rotational symmetry 100. The boom 80 with means to be bent or straight. A front suspension 20 helps support the yard tool 10 operation which is explained in more detail below.

The power source extends power from the drive shaft 70 center of rotational symmetry 100 to the boom 80 lower end and beyond to the cutting disk 60. The drive shaft 70 having the means to be splined (partially shown), solid or tubular shaped and is capable of converting similar work load from an auxiliary blower (not shown) to the cutting disk 60 outer tip 64. The cutting disk 60 operated in front of an operator substantially within mirrored single orthogonal fold frameworks. It is known to the art that the cutting disk 60 disturbances will transmit power back up the boom 80 when meeting high resistance. Accordingly, a bracket 30 connects to the boom 80 front end so that a front suspension 20 of the invention will help control shock during the yard tool 10 operation. The bracket 30 having a plurality of functions so it is crucial that one or more of the parts be all made of very durable metallic alloy, composite fiber and the like. The bracket 30 will employ yard tool elements like a blower housing (not shown), a string trimmer shield or the like with composite fiber material associated with approved crash helmets whereas reinforced steel is commonly utilized on the bracket 30 for a steel lawn edger guard or the like. In this case, the blower housing typically has a stack (not shown) that permits the front suspension 20 to couple to the bracket 30 with respect to the yard tool 10 center of mass being balanced over a frame 22. Alternatively, the bracket 30 is capable of holding a plurality of other objects made up of standard reinforced steel, aluminum, titanium, or composite fiber materials when the front suspension 20 is implemented to support the yard tool 10 in equilibrium.

The front suspension 20 is adaptable to a plurality of frames 22 of different geometric shapes. The frame 22 coupled to the bracket 30 at the front suspension 20 proximal end having one or more wheels 40 mounted to the frame 22 bushing (not shown) at a distal end to roll the yard tool 10 ergonomically over hard surfaces in one of the orthogonal isomer frameworks. The frame 22 of FIG. 1 is constructed of ultra light tandem spokes of the lightweight steel, aluminum, titanium, or composite fiber material type that may remain semi-opened or transparently closed. The purpose of the wide axle frame 22 is to improve the yard tool 10 stability to better the yard tool 10 operation. The frame 22 having a straight or curved shape that couples to the the boom 80 according to sound engineering judgment. The frame 22 with means for a skid, a fender and a shock absorber, but the stand alone dual spoke frame 22 already provides 10 reasonable dampening benefits with less weight. The yard tool 10 capable of supplying additional debris protection and is an ideal guide for limiting tilting of the yard tool 10.

The wheel 40 made up of thin ABS material or the like that aligns parallel to the cutting disk 60 tip 64. The wheel 40 is capable of lateral and longitudinal reposition between the pair of single orthogonal fold frameworks. A thin auxiliary tire tread or shock absorber (both not shown) may be added to the wheel 40 or the frame 22 for dampening qualities. The wheel 40 is sufficiently separated from the cutting disk 60 to dampen vibration. A pair of posts 42 keeps the front suspension 20 confined between the yard tool 10 vertical operating frameworks by pushing forward on the wheel 40. The posts provide operator stride protection from the cutting disk 60 and will add extra strength to the frame 22 during lawn care operation.

The front suspension 20 is facilitated mainly for vertical lawn edging, yet is implemented as a safety guide to prevent cutting disk 60 outer tip 64 wounds to property improvements and sensitive vegetation as well as produce a longer and straighter cut. It is important to note that the front suspension 20 is able to float above a grounds surface so that loose objects like tree mulch won't get wedged between the frame 22 and wheel 40. The handlebar with means for the front suspension 20 to fold into the orthogonal isometry off of soft grounds cover to make height adjustments over moderate clumps of vegetation and piles of debris. This accurate fold method is more forgiving with resistance and is less likely to stir up debris because the softer or looser grounds surface absorbs much of the forces. Therefore, the front suspension 20 may not be required to perform vertical lawn edging on soft vegetation, but is ultra handly for completing vertical lawn edging chores or transporting the yard tool 10 long distances over hard pavements. A dial 38 adjusts the front suspension 20 for right or left handed yard tool 10 use by pulling downward on the frame 22 until the yard tool is set in a desired cruise position. The front suspension 20 is capable of being held in balance during grounds trimming operation whether the shield 50 is a symmetrical or asymmetrical unit because the dial 38 will center the wheel 40 over the center of rotational symmetry 100 or position the wheel 40 diagonal to an asymetrical shield for better balance.

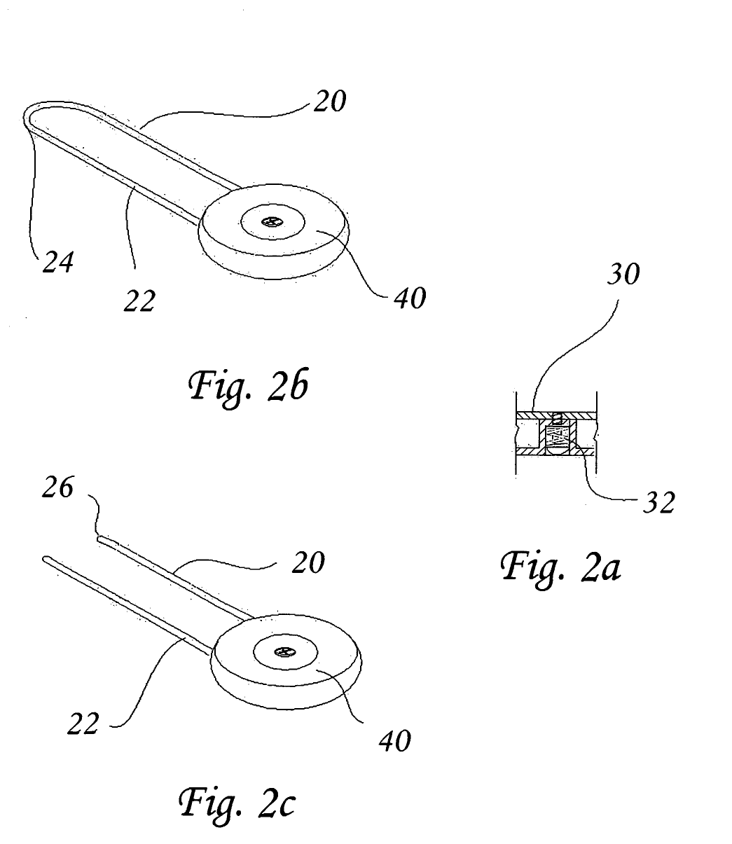

Referring to FIG. 1-2c, the dial 38 adjusts the front suspension 20 by expanding one or more springs 32 shown in FIG. 2a adjusting for. However, the front suspension 20 has means to be bolted down and loosened with standard hardware and tools. The spring 32 further maintains balance of the cutting disk 60. The front suspension 20 preferably having a loop 24 frame 22 that connects to the bracket 30 prior to the cutting disk 60 assembly. However, a quick release plunger frame 26 embodiment of FIG. 2c or the like can be coupled to the bracket 30 for efficient linkage and removal of the front suspension 20 free of cutting disk 60 handling. The loop 24 and quick release plunger 26 frame 22 embodiments have means for removal to reduce the yard tool 10 packaging material and will lower the weight if landscape work is regularly soft applications. The plunger frame 26 capable of coupling to the shield 50 (not shown) for primary horizontal grounds trimming and secondary lawn edging support. The shield 50 and other boom 70 central locations may be used to hold the plunger frame 26 for convenient storage. It is recommended that the primary front suspension 20 for lawn edging be substantially positioned under the yard tool 10 center of mass ahead of secondary shield 50 support for superior yard tool 10 cutting and balanced equilibrium in all operative and inoperative positions.

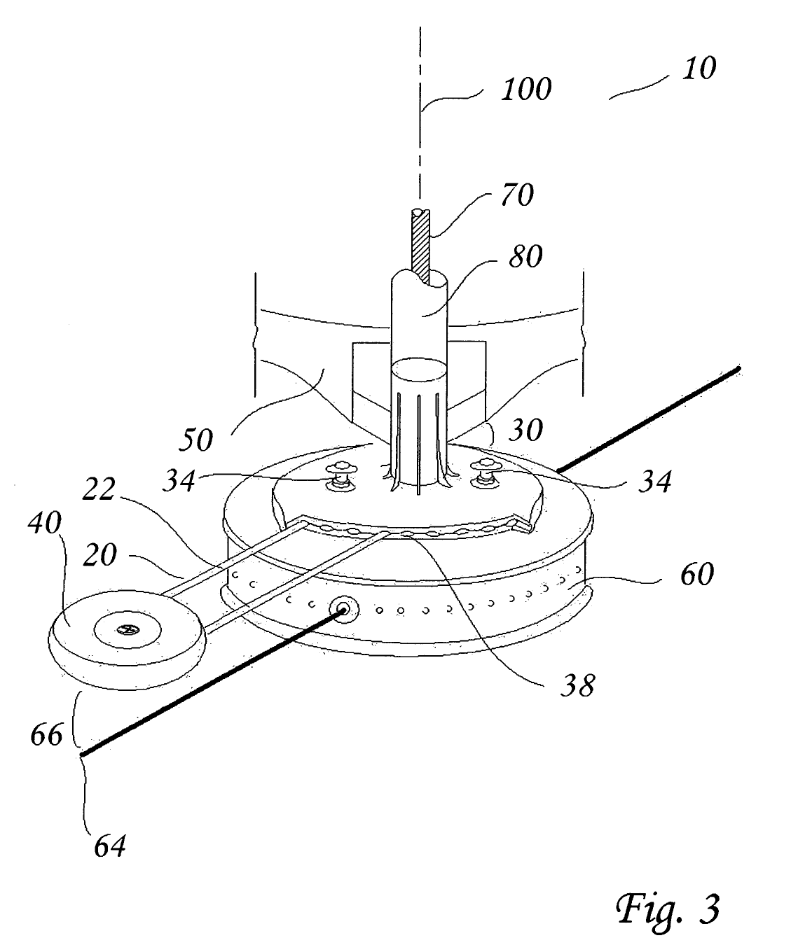

Referring to FIG. 3, the bracket 30 containing a pair of auxiliary knobs 34 that manually lock down the front suspension 20 into a desired bracket 30 position. The knobs 34 can be substituted with standard fasteners or the like. The knob 35 embodiment is loosened to dial 38 the front suspension 20 about one hundred and ten degree alternate vertical cutting cycles when the shield 50 wall widens to at least a seventy degree symmetrical angle or about twice the boom 80 holding angle. These angles are key safety aspects of the invention and will help save energy. The knob 34 lock down method is generally alternated after each yard tool 10 use to even out resistance similar to mowers changing directions after each cycle to even out stress.

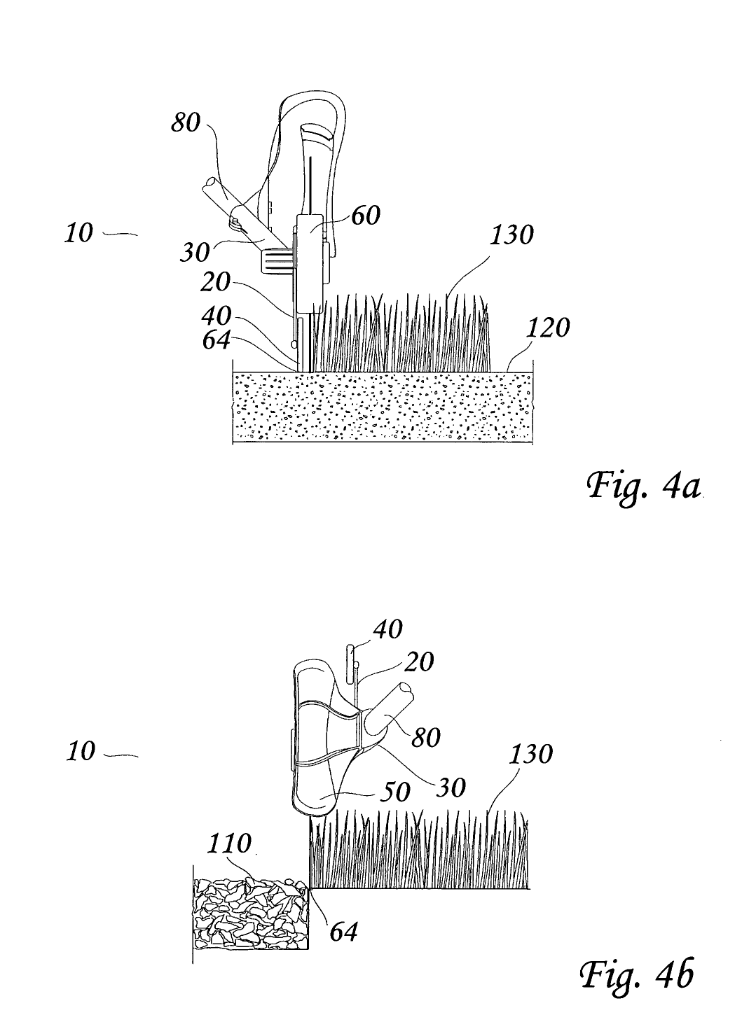

Referring to FIG. 4a, the front suspension 20 aligns with the cutting disk 60 outer tip as a tool guide, but more importantly for minimizing the yard tool 10 disturbances. The wheel 40 and vertical soft grounds cover 130 both act to dampen the cutting disk vibration for a straight and longer cut. There is a considerably more cutting disk 60 outer tip 64 stability and a finer soft vegetation 130 vertical cut in relation to Ser. No. 12/148,910. The boom 80 logically shows that an operator will likely walk on a hard grounds surface 120 diagonally away from debris dispersion with safety and cleanliness in mind. Simultaniously, the hard grounds surface 120 may shock an operator more during transport (not shown) of the elongated boom 80 elements (partially shown) which is another reason why the front wheel 40 suspension 20 is important.

Referring to FIG. 4b, it is known to the art that tilting a string trimmer from horizontal can scalp soft grounds cover 130 and will stir up and deflect loose grounds cover 110 upward which is costly. Furthermore, professional landscapers insist on accuracy so they will sometimes give up on old models in order to fold the yard tool 10 into a precise, yet awkward orientation for vertical lawn edging. Hence, a single orthogonal lawn edging fold will not only provide an appropriate cut, but the loose 110 and soft 130 grounds material substantially dampens the operation while the cutting tip 64 is tucked in a narrow position to minimize debris dispersion.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A front suspension for a yard tool comprising:
a yard tool;
the yard tool having a power source;
the yard tool having means for a cutting disk free of using a tool;
the yard tool having means for a shield;
the yard tool having a drive shaft;
the drive shaft substantially contained within a boom;
the boom suspended and controlled by a handlebar;
the cutting disk, handlebar and power source mounted on the boom center line of rotational symmetry;
the cutting disk substantially operated within mirrored single orthogonal fold frameworks;
a bracket mounted to the boom;
the bracket having means to support the drive shaft, the cutting disk, the shield and one or more front suspensions;
the front suspension having means to dampen the power transfer;
the front suspension having a frame;
the frame connected to a wheel or the like at a distal end and coupled to the bracket at a proximal end;
the front suspension operated parallel to the single orthogonal fold frameworks;
the front suspension having means for height adjustments of the yard tool;
the front suspension operated substantially below the yard tool center of mass;
the front suspension having means to support the yard tool in equilibrium in all operative positions;
the front suspension having means to support the yard tool in equilibrium in all inoperative positions;
the front suspension having means to save power;
the front suspension having means to guide the cutting disk with a longer and straighter cut;
the front suspension having means to dampen the cutting disk resistance adjacent to hard surfaces; and
the handlebar having means to fold the front suspension away for the shield and cutting disk to perform soft yard grounds work.
